(19) United States
(12) Patent Application Publication
(10) Pub. No.: US 2016/0005242 A1
(43) Pub. Date: Jan. 7, 2016

(54) Predictive Automated Maintenance System (PAMS)

(71) Applicants: Tri T. Hua, San Diego, CA (US); James R. Ritchie, JR., Chula Vista, CA (US); Cynthia Nguyen, San Diego, CA (US)

(72) Inventors: Tri T. Hua, San Diego, CA (US); James R. Ritchie, JR., Chula Vista, CA (US); Cynthia Nguyen, San Diego, CA (US)

(73) Assignee: United States Government as Represented by the Secretary of the Navy

(21) Appl. No.: 12/398,736

(22) Filed: Mar. 5, 2009

(51) Int. Cl. G07C 5/00; G06F 17/30; H04L 29/08; G07C 5/08; G06F 11/07

(52) U.S. Cl. CPC G07C 5/008; G07C 5/0808; G06F 17/30241; H04L 67/025

(57) ABSTRACT

A method of performing preventative, routine and repair maintenance on a plurality of geographically remote units includes the step of establishing a Common Core System (CCS), or portion of a unit under test (UUT) component that has a common configuration for each unit. The CCS can be established at manufacture, or it can be back fitted by hardware implementation on legacy UUT's. Each CCS is networked to an Advanced Automated Test System (AATS), which is further networked to a central knowledge database and to a plurality of remote users. The remote users can access the AATS through the network to conduct remote tests of the UUT through the CCS, and to troubleshoot the UUT in response to a UUT test fault. The central knowledge database can further store configuration and operation history for the UUT, to maintain configuration control and to predict a Mean Time Between Failures (MTBF) for the UUT.

### FEDERALLY-SPONSORED RESEARCH AND DEVELOPMENT

This invention (Navy Case No. 097641) is assigned to the United States Government and is available for licensing for commercial purposes. Licensing and technical inquiries may be directed to the Office of Research and Technical Applications, Space and Naval Warfare Systems Center, San Diego, Code 2112, San Diego, Calif., 92152; voice 619-553-2778; email T2@spawar.navy.mil.

### BACKGROUND

1. Field

This disclosure relates to computer networking. More particularly, the disclosure relates to the use of a networked system for remote management of maintenance functions for a plurality of units.

2. Background

Current conventional time-phased or on-demand shipboard maintenance systems are often costly, time consuming, behind schedule, and ineffective for sustaining battle force missions. Preventive maintenance and logistics support are often based upon outdated assessments. Further, a significant number of reported misdiagnosed maintenance issues impact negatively on onboard stores allotment and preventive maintenance requirements.

In general, it is noted that ordinary maintenance procedures tend to be insular, in that a maintenance schedule for a particular system or component is determined and disseminated, and failure modes are observed. Often it is the case that a maintenance problem which can easily be remedied is addressed as a series of reactions of modifications and service bulletins, but without fully addressing the problem in the context of an aggregate of information collected. The use of expert knowledge thereby tends to be confined to correction after failure, techniques for correction after failure, or modification of replacement parts. While component failures and anticipated repairs are communicated to both the manufacturing and repair supervisory functions, there is a tendency to ignore the aspect of adjusting preventative maintenance in response to a pattern of failure modes.

Existing systems often use proprietary technology that is coupled with databases established for the purpose of predicting when failures in equipment will occur. As a result, these systems are often stove-piped, in that there are no automated interactions and sharing of data with other systems to: 1) Accurately predict failures; 2) Remotely conduct maintenance with little or no shipboard personnel interaction; 3) Automatically generate cost and maintenance records for ship and shore maintenance and engineering organizations; 4) Automatically search and locate parts within a squadron, group, area of responsibility (AOR), or within the defense supply system; and, 5) Create and access robust historical files for a specific ship, system, equipment, or part.

In addition, there are high personnel turnover rates onboard fleet units. As a result, the technical manpower changes frequently and the accumulated knowledge and “know-how” related to unit repair is lost. As a result, a significant amount of resources are spent on repeated training of onboard manpower and on misdiagnosis of failures due to lack of knowledge or expertise.

Additionally, the databases for such systems are generated using data that often is less than ideal. Currently, remote shipboard personnel are responsible for performing preventive and corrective maintenance, updating configuration changes, and providing maintenance requirements and configuration change information to central databases that collect data to track system configuration status, fleet maintenance and material readiness. Because shipboard personnel are often relatively inexperienced at performing these functions, and due to the high turnover rate cited above, configuration change data may often times be entered incorrectly, or not at all. As a result, decision makers may be using faulty data to make scheduled maintenance actions and logistics decisions.

At the same time the maintenance disadvantages cited above exist, communications links, computer-processing techniques, and miniaturized electronics have given the U.S. armed forces global connectivity, powerful sensors, and weapons with increased precision and lethality. Near real-time collection, analysis, and dissemination of information coupled to advanced computer-driven decision aids helps a variety of military units to increase their responsiveness and survivability. A reduction of future fleet operations and support costs, particularly manpower reduction, can be achieved by applying this capability to process and disseminate information to the fleet maintenance problem. Stated differently, it is desired to leverage this information processing and dissemination capability and apply the capability towards the automation of fleet maintenance through net-centric enabled system capability. It is essential to change the naval maintenance concept to take advantage of the Command, Control, Communications, Computers and Intelligence (C4I) net-centric system availability and reduce future fleet operations and support cost.

In view of the above, it is an object of the present invention to provide for remote static and dynamic testing for predictive and automated failure analysis. It is another object of the present invention to incorporate configuration management and virtual supply functions, distance training and helpdesk support, and remote test program development and insertion in a networked environment. Yet another object of the present is to provide a system that provides near real-time remote display of system operation status of all net-centric enabled shipboard equipment configured with the PAMS maintenance test/diagnostic capability. Still another object of the present invention is to provide a system that tracks system behaviors and uses advanced analytic models to predict equipment faults and/or recommend replacement before the equipment fails. Another object of the present invention is to provide a system that tracks and stores results of self-tests, operational status, configuration management data in a central database.

### SUMMARY OF THE INVENTION

A method of performing preventative, routine and repair maintenance on at least a plurality of geographically remote units according to several embodiments of the invention includes the steps of establishing a Common Core System (CCS) for each of the remote units. The CCS can be thought of as the portions of a system or component of the remote units that have a common configuration. The CCS can be a portion of a unit under test (UUT), or the CCS can be equivalent to the UUT if the entire UUT has a common configuration for the remote units. The CCS portion of the UUT can be established at manufacture, or it can be back fitted by implementing hardware into the UUT, such as an additional circuit card, or a multi-pin connector with an extra pin that allows for transmittal of data to and from the UUT.

The methods of the present invention can further include the step of linking each CCS to an Advanced Automated Test System (AATS), which is an ATS that is connected to a network. The ATS has hardware and associated computer that allow for communication between the AATS and the CCS for remote testing of the UUT. With this configuration, a plurality of networked remote users can access the AATS to conduct a test of the UUT through the CCS remotely, and also troubleshoot and repair the UUT in the event that a test results in a UUT fault. The remote users can include system subject matter experts that are not located at the AATS/CCS, provided the users are connected to the same network as the AATS.

The methods can further include the steps of providing a central knowledge database, and linking the central knowledge database to the UUT and to the AATS. The central knowledge database can include a plurality of configuration information for the UUT, as well as common test fault information and corrective information pertaining to correction of common (and uncommon) test faults. Operational data for the UUT's of each remote unit could also be stored in the central knowledge database. With this configuration, the PAMS could record operating hours between reported equipment failures for the UUT to predict a Mean Time Between Failure (MTBF) for the UUT. The central knowledge can also store configuration update information for the UUT, to maintain configuration control for UUT system or component at a central location that can be accessed by remote users.

### BRIEF DESCRIPTION OF THE DRAWINGS

The novel features of the present invention will be best understood from the accompanying drawings, taken in conjunction with the accompanying description, in which similarly-referenced characters refer to similarly-referenced parts, and in which:

FIG. 1 is a general diagram which shows a networked operation of advanced automated test set (AATS) components;

FIG. 2 is a diagram of PAMS, which shows the networked testing of a group of receiver components; and,

FIG. 3 is a diagram depicting implementation of the PAMS in a naval fleet environment, on fleet assets that are remotely located.

### DETAILED WRITTEN DESCRIPTION

Overview and General Concept

The present system presents a predictive and automated maintenance system (PAMS) that supports shipboard manpower reduction and establishes the foundation for an advanced automated maintenance and logistics support for a plurality of remote fleet units. Current conventional time-phased or on-demand maintenance for shipboard equipment is very costly, time consuming, behind schedule, and ineffective for sustaining battle force missions. It is essential to change the current maintenance concept to take advantage of more advanced Command, Control, Communications, Computers and Intelligence (C4I) network availability to reduce future fleet operations and support cost.

The PAMS allows for remote configuration management of supported systems. The PAMS facilitates the transformation from a local maintenance paradigm to a net-centric paradigm to remotely manage and maintain fleet systems. The PAMS facilitates this transition by utilizing a networked environment to provide a central resource of shipboard systems, maintenance status and configuration accounting

The PAMS: 1) Allows maintenance personnel to remotely perform system operational/verification tests and support ship personnel conducting the repair of equipment via a network; 2) Provides near real-time remote display of all net-centric enabled shipboard equipment configured with PAMS maintenance test/diagnostic capability; 3) Sends results back to the shore-based maintenance personnel executing the tests; 4) Provides shore-based maintenance personnel with the same feel and knowledge as if the shore-based personnel were on the ship performing the diagnostic test; 5) Automatically schedules maintenance when the system is not in use or ship activity is low; 6) Allows scheduled maintenance to be manually started or to be overridden by shipboard personnel in response to change of mission requirements; 7) Stores all test results, system status and shared data in a central knowledge database; 8) Captures current system operational status and system configuration data and stores it in the central knowledge database; 9) Automatically detects and registers any hardware/software change in shipboard equipment configuration, track system changes and support force C4I configuration management; and, 10) Provides remote and local training in the conduct of maintenance and diagnostic tests of covered systems.

It is noted that the following written description relates to example configurations used for shipboard maintenance. The use of PAMS for shipboard maintenance is given by way of non-limiting example, as the techniques are suitable for a wide variety of aggregate units, including without limitation, taxi fleets, power plants, buildings, large fleets of vehicles and other similar groups of systems, provided that these systems have some portion of their system and components configurations in common with each other. The PAMS provides, with the assistance of operators, technicians, or engineers, “virtual maintenance” by personnel that are connected to a distributed network, as described in more detail below.

### Configuration Examples

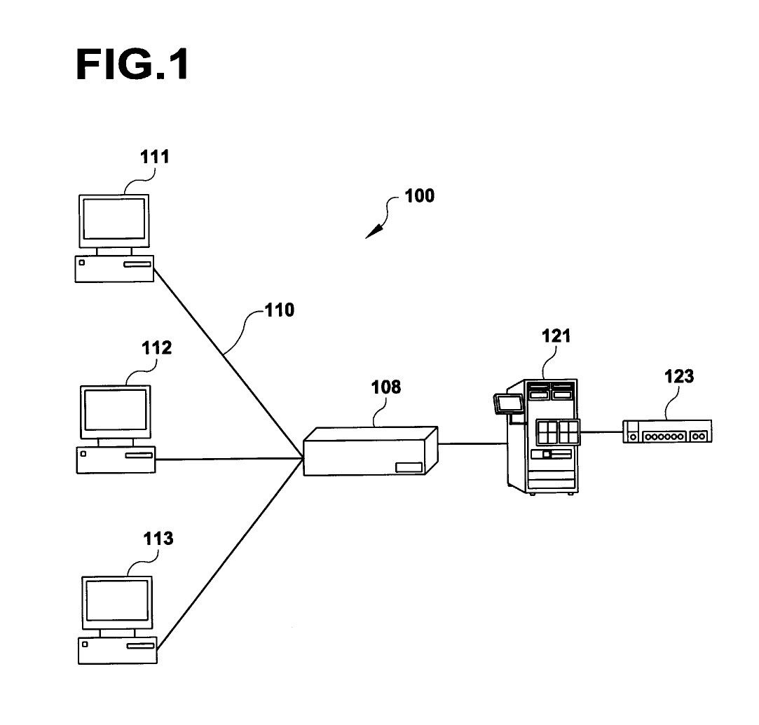

Referring now to the Figures, FIG. 1 is a diagram showing a Predictive and Automated Maintenance System (PAMS) network operation. Depicted is a network server 108, in communication with multiple end users 111-113 through communications link 110. Also connected to the network server is an advanced automated test station (AATS) 121 for testing a unit under test (UUT) 123. An AATS is an automated test station that is connected to a network. The AATS permits multiple remote end users 111-113 to operate the automated test station 121. This configuration allows the testing tasks to be performed at remote locations so that the end users 111-113 need not be physically located at ATS 121 to control testing of the UUT 123. This ability therefore provides a model for remote testing.

An additional feature of the configuration in which multiple end users 111-113 are able to communicate with AATS 121 through the network server 108 is that if end users 111-113 have additional information or computing capabilities, they can use these functions in connection with the operation of AATS 121. For example, if user 111 has access to an expert system or a database of error logs, user 111 can apply this information to the operation of AATS 121. User 111 can also be at a remote location from AATS 121. Therefore, if user 111 is specialized in the test and maintenance operations relevant to UUT 123, user 111 is able to apply the specialized expertise to testing UUT 123 without physically being at the location of UUT 123.

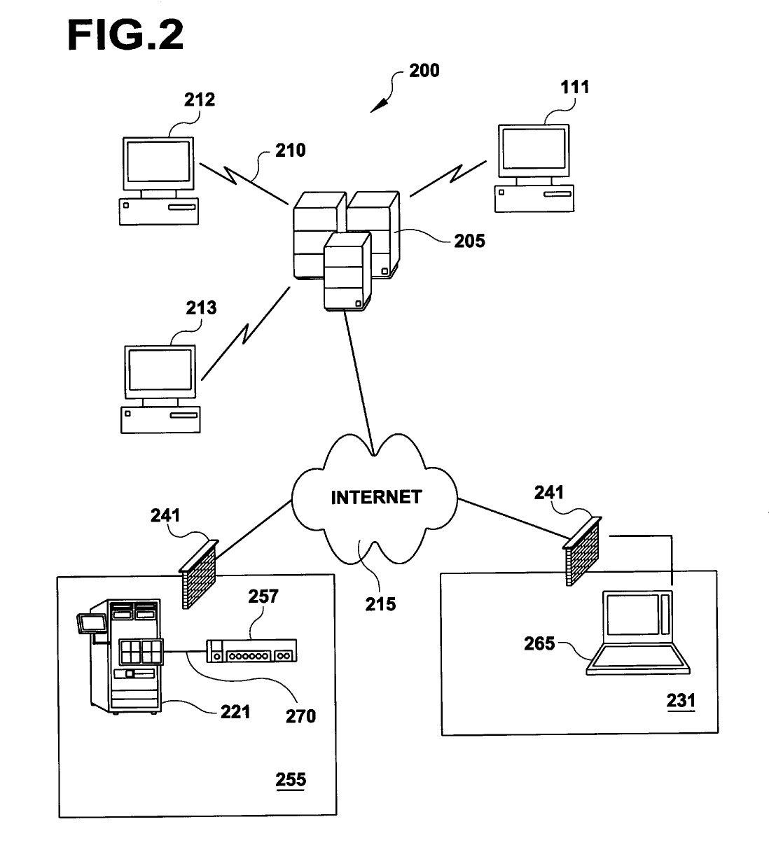

FIG. 2 is a diagram showing generally PAMS 200 for the testing of a group of receivers, of which receiver 257 is representative of a UUT. The configuration presents an enhancement to the capabilities of the system of FIG. 1. A central knowledge database 205 for communicating with end users 211, 212, 213 via communications link 210 is shown in FIG. 2. The central knowledge database 205 also communicates directly or through a network connection (such as the internet, 215 via network servers that are not shown in FIG. 2), with AATS 221 at test site 255 and with other information assets, such as a system expert 265 at on-shore facility 231. The communications links may be secure or non-secure, and the link connection may be via the internet 215 through firewalls 241.

The central knowledge database 205 can be a single database or multiple databases, and can be at a single location, or may be at different locations throughout the system 200. In addition to other information assets at on-shore facility 231, it is also possible to utilize data external to the system 200 for information associated with the central knowledge database 205, as for example when information is obtained by searching the internet or searching external documents.

Test site 255 is depicted as including an AATS 221, which may be used to test a UUT (the UUT in FIG. 2 is receiver 257). The other information assets may be end users 211-213, a system expert 265 or other facility which can be used for controlling testing as an additional end user, a facility for standalone testing which can be augmented with the system 200, or a combination of such end users, system experts and facilities.

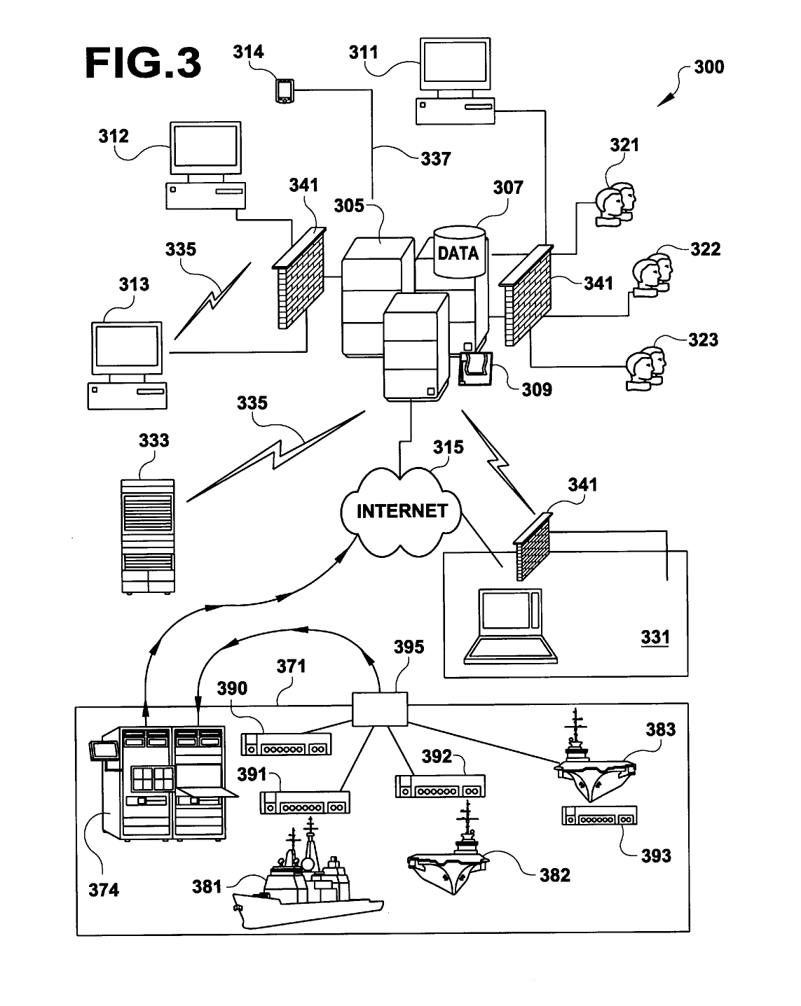

FIG. 3 is a diagram showing implementation of PAMS 300 in a naval fleet environment. Depicted are central knowledge database 305, which is depicted as including a data store 307 and report generating facility 309. The central knowledge database 305 communicates with end users 311, 312, 313. Also depicted are alternative end users, such as and end user with a handheld access device 314. Additional end users can also include separate end groups 321, 322 and 323, who may communicate through user terminals or other devices (not shown). Also shown are FORCEnet network component 333, which is a Navy-specific network hub that can be connected to the network, and on-shore facility 331. Several of the units communicate through external networks such as wireless communication links 335 or hardwired local area networks (LAN's) 337 via secure switches and routers, and through internet 315, via firewalls 341.

FIG. 3 also depicts external connections to an external test domain 371. The external test domain 371 is depicted as including an AATS 374, and ships 381, 382, 383. External ATS 374 and the ships 381-383 include one or more common core systems (CCS) 390, 391, 392, 393, respectively, which form communication and control links to the central knowledge database 305. The PAMS components, including the CCS, are described more fully below.

PAMS Components and Modes of Operation

There are 4 main components in the predictive and automated maintenance system: 1) Common core system (CCS); 2) Advanced Automated Test System (AATS); 3) Central knowledge database; and, 4) Distributed network with web service application.

The CCS is the portion of unit components or systems that shares a common hardware and/or software configuration, and includes the means for transferring information between the UUT and the AATS. In situations where the entire UUT structure has a common configuration, the CCS would be equivalent to the UUT. If only a portion of the UUT is common, then the CCS would be a portion, or a subset of the UUT structure. The CCS includes two categories of components: (a) CCS Components that link to the UUT to the AATS to report information pertaining to the UUT, including network components such as servers, routers, switches, firewalls, workstations, etc.; and, (b) CCS Components that can be manipulated remotely by networked end users through the AATS, such as software applications, variety of hardware components and shipboard equipment such as radio, power generator, radars.

Remote Testing and Diagnostic Hub (RTDH) 395 in FIG. 3 is an example of a CCS linking component. In several embodiments, it may more feasible to connect several CCS's to the same AATS 374. In those embodiments, the CCS-AATS interactions are routed through RTDH 395. If more secure data transfer arrangements are required, additional firewalls (not shown) could be added to CCS 390-393 and RTDH 395, and between RTDH 395 and AATS 374. The CCS components that build the network are monitored and maintained through commercially available network management systems. The CCS hierarchy enables several layers of communication between systems, subsystems and components.

The CCS components that allow for use of the CCS by networked remote users through the AATS are modular, scalable, reconfigurable and have an open architecture. CCS shipboard systems replace existing shipboard equipment and have embedded sensors and a UID system to identify each unit/sub-unit for tracking system hardware/software configuration changes. The sensors transmit and receive data through FORCEnet infrastructure (physical lines, radio communication, etc.). Examples of such components are circuit cards and multi-pin connectors. These CCS components can be installed on new versions of UUT's, or they can be back fitted to legacy UUT components.

As briefly mentioned above, the Advanced Automated Test System (AATS) is a networked ATS. The AATS includes Automatic Test Equipment (ATE) hardware and its operating software and Test Program Sets (TPS) which include the hardware, software and documentation required to interface with and test individual weapon system component items, and associated software development environments. The term “ATS” also includes on-system automatic diagnostics and testing. An AATS allows for, by way of non-limiting example, operation of ATS in a virtual environment or for an ATS that could include predictive qualities based on past historical data for PAMS-supported systems and components.

The AATS is a modular, scalable, re-configurable and provides an open architecture. When a system or subsystem fails during self test, the CCS assigns AATS to the appropriate failed system for further diagnostics and troubleshooting. This could be accomplished using readily available commercial-off-the-shelf (COTS) computer software technologies such as PCI eXtension for Instruments (PXI), Synthetic Instruments, and LAN eXtension for Instruments (LXI), although other commercial products could also easily be used without departing from the scope of the present invention. Each AATS provides its own client application for reporting system status and test results to the central database.

AATS facilitates remote technical support by allowing an onshore station to remotely take control of an off-shore CCS through its network connection to the AATS and connection between the AATS and the CCS. This feature enables a central maintenance center to run and troubleshoot PAMS-supported systems remotely, while keeping a center of excellence with experts in one location, or even if the experts were scattered remotely, allow for expert support, provide the remote subject matter expert has network access to PAMS. The AATS helps minimize the number of units sent back for repair on-shore and increase the onboard repair capabilities, saving valuable down-time and resources.

The central knowledge database 305 stores PAMS information, which includes but is not limited to, type of equipment (manufacturer, model, type, age, etc.), location, component repair history, utilization information (hours used, hours out of service, etc.), scheduled maintenance, version of software/firmware and/or hardware, past test results, Test Program Sets (TPS) routines, documentation and instructions, component status (ready, under constructions, unusable, etc.) and component literature (user manuals, schematics, wire lists, operation instructions, drawings and pictures). This information is collected from remote fleet units and is stored at the central knowledge database 305. End users 311-314 and end groups 321-323 are able to access the central knowledge database 305 to obtain information about previous system failures and repairs, suggested troubleshooting and recommended actions based on past experience of similar problems from on-shore facilities 331 and system experts 265. This net-centric repository provides the entire fleet with real-time access to valuable data, which results in reduction of training time and the prediction of more accurate Mean Time Between Failures (MTBFs).

As shown in the Figures, the PAMS further includes distributed network with web service applications permits pre-existing maintenance equipment to link to the central knowledge database 305, end users 311-314, end use groups, to the AATS, and further from the AATS 374 to the CCS's 390-393. The distributed network can comprise the internet 315, LAN's 335, wireless links 337, firewalls 341 or any combination thereof. The distributed network allows remote units to take advantage of information resident in the pre-existing maintenance equipment or to use the pre-existing maintenance equipment across the network. Further, the distributed network with web service application allows information which becomes resident at any part of the system to be shared, either in real time or upon periodic updates of data.

FORCEnet is a Navy network hub 333 that provides the net-centric and distributed network with client-server modules and web service applications infrastructure for PAMS support of naval vessels. As such, FORCEnet provides Navy-specific network functions such as, software deployment and migration, hardware configuration, asset management and remote support. This capability allows PAMS a remote communication between its network components, data repository, messaging and services that are Navy-specific. It should be appreciated, however, that PAMS as described herein could be operated without FORCEnet hub 333 connected to the PAMS network, or alternatively, with a different organization-specific network hub connected to the PAMS network.

The PAMS includes computer software that automates the following capabilities for monitored system and subsystem: 1) A system Built-In Self Test (BIST); 2) A System Operation Verification and Test (SOVAT); 3) System configuration changes; and, 4) Interactive guided training and repair guidelines. These capabilities are typically built into the CCS and are considered as part of the CCS structure.

The BIST runs automatically in the background without affecting system performance. The BIST includes “smart” process-efficient algorithms that check the status of the system without degrading system performance and readiness. BIST will prompt users about system problems and alert responsible network users for corresponding support action as necessary.

The SOVAT runs when the system is not in use or when ship activity is low. The SOVAT may be automated so that it runs without or with minimum ship personnel interventions. Remote users will selectively activate PAMS to run SOVAT's in real-time and troubleshoot the system to alert ship personnel for corrective action.

The monitored system hardware and software configuration changes are collected automatically, and ship personnel will automatically be alerted to any changes. The CCS Unique Identification (UID) component will enable this feature. As with today's personal computers, the UIDs will identify the hardware and software being installed on each UUT that is being monitored by the PAMS. Thus, PAMS provides an additional capability for tracking configuration changes, statistics, and trends for management evaluation of the fleet modernization effort.

The Interactive guided training and repair guidelines are available for remote technical personnel, to make accumulated knowledge from generations of expertise available to technicians located on remote fleet units. Using the Interactive guided training and repair guidelines, operators and technicians are able to self-train on ship systems and subsystems with interactive software-based tools, which can be loaded into the AATS. They software-based tools also provide access to Smart Virtual Repair Centers (which can be part of data 307 that is accessed via the central knowledge database 305) as the first resource for information and suggested repair path.

The PAMS provides three maintenance modes of operation: 1) Preventive; 2) Automatic; and, 3) Manual. All three operational modes are available for all monitored systems and subsystems and could be enabled or disabled based on the relevant activities or user requirements. As the name implies, the Preventive mode is directed to preventive maintenance and is based on a knowledgebase that accumulates over time. In Preventive mode, each CCS registers its hours of operation and any malfunctions or warnings in the central database. Each system and subsystem is configured for a pre-scheduled maintenance activity based on the type of equipment, its operational status, and its level of usage (e.g., radar maintenance is required every 1200 hours of operation). However, when necessary, the operator may override the predefined schedule and decide which common core system is tested and how often. Preventive mode results also provide information for scheduled onboard or on-shore required calibration of system components. The automated preventive maintenance scheduling by PAMS significantly reduces unpredicted failures and repairs, which are a major source for system down-time, without relying on ship personnel.

The Automatic mode is used to perform pre-scheduled maintenance and monitoring functions. To verify the health of PAMS-monitored system components, the automatic maintenance mode performs periodic predefined tests and diagnostics on each common core system (e.g., network components scanned twice a day). The Automatic mode performs the tests and diagnostics simultaneously with the system regular operation without interfering or degrading the overall performance. The main purpose of the Automatic mode is to assure system readiness and immediately notify both remote and local PAMS users possible component malfunctions. The automatic maintenance data provides near real-time information of overall systems health and availability.

The Manual mode enables user-initiated verification of any common core system at any given time. The Manual mode allows an onboard (local) or remote on-shore user to perform system tests and diagnostics. The Manual mode provides the user with the proper tools to select a full or partial test of any PAMS-capable system or subsystem.

PAMS Fleet-Wide System Configurations Monitoring and Control

Fleet-wide monitoring is described as a non-limiting example of the use of the PAMS to increase efficiency of maintenance of a group of assets.

In general, the monitoring of an individual unit or component is unlikely to disclose a trend related to a failure mode for a plurality of those units or components. If, for example, particular conditions cause premature lubricant failure, such as molecular breakdown or polymerization, this is traditionally noted either by sensing the actual condition on an individual basis, or by receiving reports and monitoring the condition of the fluid or components. This approach is somewhat happenstance because there are instances where ordinary monitoring may not disclose unusual results prior to problems developing. Part of this is because the failure mode is unexpected, at least in the case of an individual component, and part of this is because monitoring and maintenance schedules are designed for ordinary circumstances.

Continuing with the example above, in the case of an automobile, lubricants are expected to last for the scheduled maintenance period, so that things like oil polymerization will not be noticed because the operator is not looking for that condition and because the condition is unusual. If, on the other hand, an instance of oil polymerization has been detected in a different vehicle, it would theoretically be possible to monitor all vehicles or to monitor all vehicles operating in similar conditions (e.g., using a particular fuel). This could be done directly, meaning for all vehicles using the particular fuel, or indirectly, for example by modifying lubricant checks on vehicles exhibiting particular fuel pressure or temperature readings. The operator would not necessarily be aware of the potential for failure, but the monitoring of the system would flag the potential problem before it results in a catastrophic engine failure. In the case of a naval fleet system, such monitoring would result in the recognition of a particular failure mode or trend, and adjust monitoring to predict the trend.

With respect to the configuration control aspect of PAMS, PAMS includes computer software that supports configuration control and management of all PAMS-monitored components. PAMS components are able to provide configuration information to a central knowledge database 205 upon request, or automatically in some cases (i.e., at system initialization).

The component configuration information includes, but is not limited to: 1) Unique Identification (UID) codes (analogous to Media Access Control Identifications, MAC IDs, in networks); 2) Hardware information—manufacturer, model, serial number, revision, firmware version, etc.; 3) All traceable hardware subcomponents installed, to include manufacturer, model, serial number, revision, firmware version, etc.; and, 4) All software packages, applications and agents installed.

The PAMS configuration control software keeps track of each component configuration. Any software or hardware replacement or upgrade will require information exchange with the configuration management module, before the component can be reincorporated. The software will verify the information provided and assure that only verified configurations are utilized. As part of the configuration control, PAMS can also tracks each component's replacement and the reason for providing replacement statistical and trend information, which could be utilized for maintenance or future modernization purposes.

Example of PAMS Operation—Single UUT Type

To provide an example of the operation of the PAMS according to several embodiments of the invention, and referring again to FIG. 2, UUT 257 may be, by way of non-limiting example, a Harris RF Communications R-2368B(V)1/URR receiver. Another example of a shipboard component that could be monitored by PAMS includes the Talla-Coms AM-7581/SRO RF linear high power amplifier (not shown in the Figures). For the example described herein, the entire UUT has a common configuration, and as such, the UUT and CCS would be equivalent structure. For other embodiments, however, only a portion of the UUT, the CCS, would have a common configuration. Referring again to FIG. 2, the test configuration includes the receiver (UUT 257), a communications link 210 that connects central knowledge database 205, system expert station 265 and end user stations 211-213. The R-2368B has the capability to be tested and calibrated remotely by remote users 211-213 through AATS, and further through an CCS network connector such as RTDH 395 (See FIG. 3), if installed. The R-2368B(V)1/URR receiver is noteworthy because it includes Built-In Test Equipment (BITE), which allows for extensive, microprocessor-controlled self-testing to verify that its main components are operational. For the R-2368B receiver, BITE is part of the CCS and includes the ability to be tested from an external source, and can be remotely calibrated. This system is able to take advantage of each of these features by transmitting commands to the UUT 257, and receive output data from the UUT 257.

The ability to incorporate a UUT into the PAMS allows incorporation of information from similar UUTs from different fleet locations. In addition, different types of UUT's can also be included into the system, so that centralized testing and maintenance may be performed on those UUT's that are on other remote platforms. The UUT's can be similar components, such as receivers of a different type or the UUT's can be common components on different system, e.g. common monitoring sensors on different water purification and monitoring systems.

As mentioned above, UUT receiver 257 in FIG. 2 contains a comprehensive Built-In Test Equipment (BITE) which allows for extensive, microprocessor-controlled self-testing to verify that its main components are operational. Communication with the receiver is via a MIL-STD-188C, EIA Standard RS-232C interface cable 270, although other interface cables could easily be used to practice the invention as disclosed herein. Normal run time of the BITE is eleven seconds with all tests performed sequentially following the RF signal path.

Prior to running the BITE, the UUT (the receiver) is configured. This can be done manually by selection of a “Configure UUT” command, which results in providing appropriate information for the receiver. This provides the receiver nomenclature, serial number, port number, baud rate and receiver ID. Now, returning to the “BITE and Functional Test” screen, the user selects from the “Receiver Tests” section by selecting “Run BITE”. This executes the BITE tests. Next, a selection is made of “Run Functional Test”. This executes the functional test. Both tests must pass and the test information must be transmitted from the UUT 257 to the AATS 221 (via interface cable 270) in order to confirm that the Receiver is operational. The screen displays for BITE and functional test provide indications of pass, fail, and warning conditions both locally at the AATS and remotely via the network to remote end users 211-213.

Table 1 below lists the tests and affected assemblies. If it is determined that a fault exists in a particular assembly, that assembly number and the corresponding fault code number are reported to the front panel display and further to the AATS through interface cable 270. The test results can be further transmitted from AATS 2221 to the network, through LAN's or wireless networks via internet protocol software.

TABLE 1
R-2368 Self-Diagnostics
Test Type Affected Assemblies

Control Circuit Tests
A14 Control Assembly
A13A2 Driver Assembly
A13A4 and A13A5 Display Assembly
Frequency Synthesizer Tests
A12 Reference Generator and A21 Frequency Standard
A11 BFO Assembly
A10 Synthesizer Assembly
Signal Path Tests
A1 Input Filter Assembly
A2 First Converter Assembly
A3 Second Converter Assembly
A4 IF Filter Assembly
A5 IF Audio Assembly
Power Supply Tests
A15 Power Supply Assembly

Table 2 below lists the fault codes for the BITE.

TABLE 2
R-2368 Fault Code Listings

| | Number | |
|---|---|---|
| Assembly | Fault | CodeDescription |
| A1 | 1 | Antenna Overload |
| | 2 | Relay Fault |
| | 3 | BITE Oscillator or A1 RF Detect |
| | 4 | Front End Filter |
| | 5 | Relay (OPEN) or DC Detect (TP5) |
| A2 | 1 | A2 Detector |
| A3 | 1 | A3 Detector |
| A4 | 1 | Bypass Signal Path Fault |
| | 2 | LSB Filter |
| | 3 | USB Filter |
| | 4 | CW Filter |
| | 5 | CW Filter |
| | 6 | Special Filter-Slot 5 |
| | 7 | Special Filter-Slot 6 |
| | 8 | Special Filter-Slot 7 |
| | 9 | A5 IF Input peak Detector or A4 IF |
| | | Amplifier and Output Circuitry |
| A5 | 1 | A5 Gain |
| | 2 | AM Detector |
| | 3 | Line Audio |
| | 4 | Product Detector |
| | 5 | Fm Detector |
| A10 | 1 | Serial Data |
| | 2 | Synthesizer Out-of-Lock |
| A11 | 1 | Serial Data |
| | 2 | BFO PLL Out-of-Lock |
| A12 | 1 | 1 MHz Reference |
| | 2 | 800 kHz Reference |
| | 3 | 40 MHz PLL Out-of-Lock |
| A13 | — | No Fault Codes (Converter Module) |
| A14 | 1 | EPROM Failure |
| | 2 | 8155 RAM Failure |
| | 3 | CMOS RAM Failure |
| | 4 | Serial Data |
| | 5 | 8155 Output Port Failure |
| | | (multiple ports B, C) |
| | 6 | 8255 Output Port Failure |
| | 7 | A/D Conversion Timing Test |
| | 8, 9 | A/D Conversion Result Test |
| A15 | — | No Fault Codes (Linear Power Supply) |
| A18 | 1 | A18 Peak Detector or A4 Output Failure |
| | 2 | A18 AGC Level Test |
| | 3 | A18 Line Audio Detector |
| A26 | 1 | Programmable Timer U22 Fault |
| | 2 | FSK Demodulator Circuit Malfunction |

An end-to-end functional test is then performed. The end-to-end functional test is actually composed of two sub-sets: the filtered and unfiltered intermediate frequency (IF) tests. The conditions of the input and output requirements are listed below.

Subset Test # 1 Filtered IF Test
1. Set Signal Generator 5 MHz output center
frequency, −50 dBm power, FM modulation
(25 kHz message frequency, 1 kHz FM deviation).
2. Set Receiver Frequency: 5 MHz, Mode: LSB
3. Select PXI-2593 #1, CH 0.
4. Set Signal Analyzer Center frequency: 455 kHz,
span: 10 kHz, resolution bandwidth: 100 Hz.
5. Measure frequency at connector J4 of max peak-
should be 455 kHz.
Subset Test # 2 Unfiltered IF Test
1. Set Signal Generator 8 MHz output center
frequency, −50 dBm power, FM modulation
(25 kHz message frequency, 1.5 kHz FM deviation).
2. Set Receiver Frequency: 8 MHz, Mode: LSB
3. Select PXI-2593 #1, CH 1.
4. Set Signal Analyzer Center frequency: 455 kHz,
span: 10 kHz, resolution bandwidth: 100 Hz.
5. Measure frequency at connector J3 of max peak-
should be 455 kHz.

A pass on both subset tests indicates that the receiver is in operational condition.

A “Receiver Operational Tests” link is used as part of the distributed network with web service application. This link brings the user to the virtual remote control interface for the Harris RF Communications' R-2368B(V)1/URR high frequency receiver. Each time the BITE or Functional Test is executed, the resulting test data with status “pass, fail or warning” is recorded in a log file stored on the server hard drive, which can be located proximate central knowledge database 205. The test results are appended to the previous test data from earlier executions and sent to central knowledge database 205. The results can be used to determine the Mean Time Between Failures (MTBF) or to determine the life expectancy a device or system is until failure. MTBF is usually given in units of hours. For various systems, one may commonly assume that during the useful operating life period, parts of the system have constant failure rates, and that part failure rates follow a Gaussian shaped distribution curve.

Failure analysis is presented in a display along with report of receivers units with “PASSED” status. On an additional note, the user is given additional versatility by being able to enter additional hours on top of recorded hours of operation. This option allows the user to perform some basic forward-looking analysis of a given receiver by determining its probability of failure.

### CONCLUSION

The use of the terms “a” and “an” and “the” and similar references in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of performing preventative, routine and repair maintenance on at least one of a plurality of geographically remote units, the method comprising the steps of:
A) establishing a Common Core System (CCS) for each said remote units, said CCS having a unit under test (UUT);
B) linking each said CCS to an Advanced Automated Test System (AATS);
C) networking a plurality of remote users with said AATS;
D) testing said UUT by said remote users through said AATS, said remote users being located remotely to both said UUT and to said AATS; and,
D1) troubleshooting said UUT while said CCS is linked to said AATS, said step D1) being accomplished by said remote users.

2-13. (canceled)
